(19) United States
(12) Patent Application Publication
(10) Pub. No.: US 2005/0149858 A1
(43) Pub. Date: Jul. 7, 2005

(54) System and method for managing documents with expression of dates and/or times

(76) Inventors: Mia K. Stern, Andover, MA (US); Daniel M. Gruen, Newton, MA (US); John Patterson, Carlisle, MA (US); Bernard J. Kerr, Boston, MA (US)

Correspondence Address: James G. Gatto;Mintz Levin Cohn Ferris Glovsky and Popeo PC, Suite 900, 12010 Sunset Hills Road, Reston, VA, 20190, US

(21) Appl. No.: 10/745,484

(22) Filed: Dec. 29, 2003

(51) Int. Cl. G06F 17/00

(52) U.S. Cl. 715/513; 382/181; 707/6

(57) ABSTRACT

An apparatus and method identifies, handles, and/or searches for email messages that include references to dates and/or times, regardless of the syntax or context in which the dates and/or times are expressed in the document. Each incoming document is searched for date-time expressions which may be converted into a canonically formatted date and stored for subsequent comparison to other date-time expressions. In some embodiments of the invention, a mechanism is provided for creating a calendar event from the date-time expression in the document. In some embodiments of the invention, a calendar icon indicates whether a document includes a date-time expression. In some embodiments of the invention, documents that include a date-time expression corresponding to a particular date may be retrieved.

### CROSS REFERENCE TO RELATED APPLICATIONS

This application is related to the commonly owned co-pending U.S. Patent application entitled “System and Method for Scrolling Within a List of Documents,” Attorney Docket No. 23452-521, filed herewith and incorporated by reference in its entirety.

### FIELD OF THE INVENTION

The invention identifies, handles, and searches for email messages that include references to dates and/or times.

### BACKGROUND OF THE INVENTION

Various conventional email systems have calendaring systems associated with them (e.g., Lotus Notes, Microsoft Outlook, etc). Even though these calendaring systems include various features for scheduling calendar events via email-like invitations, appointments, tasks, and/or other calendar events, many users still provide notice of various events via regular email messages without benefit of the calendaring system. However, these event notices in email messages do not automatically schedule corresponding calendar events in the calendaring system. As a result, users are required to manually schedule calendar events in order to track the events notices provided via the email messages. Unfortunately, many users seldom take the time to do so. Some users may not wish to schedule certain calendar events in their calendaring systems, but nonetheless, may wish to later locate these event notices and their corresponding email messages by the dates referenced in the email message.

Contributing to this problem, dates and/or times expressed in email messages can be conveyed using a variety of syntax and/or different contexts. For example, some syntax may include December 31, 2003, 12/31/03, 31 December '03, Wednesday, Dec. 31, and other syntax, while some contexts may include tomorrow, next week, every other Tuesday, end of the month, and other contexts. Because of the variety of ways in which dates and/or times can be expressed, users do not have an effective mechanism by which the dates and/or times can be searched. For example, Dec. 31, New Years Eve, the last Wednesday of December, and 12/31/03 may all refer to the same date. Even if the user remembers the date mentioned in the email message, the user may not be able to retrieve the email message using a conventional search tool, in order to, for example, recall information particular to the event.

What is needed is an improved mechanism for identifying, handling, and/or searching for email messages that include references to dates and/or times regardless of the syntax or context in which the date and/or time is expressed.

What is also needed is an improved mechanism for scheduling event notices provided in email messages as calendar entries in a calendaring system.

### SUMMARY OF THE INVENTION

The invention includes an improved mechanism for identifying, handling, and/or searching for documents, including email messages, that include references to dates and/or times, regardless of syntax or context in which the date and/or time is expressed in the document. In some embodiments, the invention may include a processing module that converts a date and/or time expression (“date-time expression”) in a document into a canonically formatted date so that subsequent comparisons may be performed from common point of reference.

In some embodiments of the invention, the processing module processes incoming documents when they arrive in the system to locate date-time expressions found in the document. In some embodiments, these date-time expressions are stored in a database. In some embodiments, this information may be accessed by various services wishing to use it.

In some embodiments of the invention, the processing module scans the text of the incoming document for expressions that might correspond to dates and times. These expressions may include words, numbers, and other expressions that may be used to convey date and/or time information. The processing module converts each expression to a canonically formatted date-time using heuristics, grammars and/or contextual information as required. In some embodiments of the invention, one or more canonically formatted date-times associated with each document may be stored in a database. In some embodiments of the invention, these canonically formatted date-times are stored with references (e.g., pointers) back to the corresponding document and in some embodiments, with references back to the corresponding date-time expression in the document.

In some embodiments of the invention, the user may perform a search using a search module. In some embodiments of the invention, a user may enter a desired date (or date range). The search module responds by returning those documents, if any, that include a date-time expression corresponding to the desired date.

In some embodiments of the invention, the search module converts the desired date into a canonically formatted date-time using heuristics, grammars and contextual information as needed, which may be similar to those used for date-time expressions. Converting the desired date into the canonically formatted date-time allows a user to enter the desired date or date range using similar syntax and/or contexts as are associated with the date-time expressions. For example, in some embodiments of the invention, a user may search for documents including “tomorrow” or “next week.”

After the desired date is entered, in some embodiments of the invention, the search module may search the database for matching entries. In various embodiments of the invention, for those matching entries, the search module may use the references stored in the database to retrieve the associated document, the corresponding date-time expression, and/or portions of the text corresponding to the context of the date-time expression in the associated document. The search results, if any, are provided to the user.

In some embodiments of the invention, an email message including a date-time expression may be converted into a calendar entry. For example, the user may select the date-time expression in a document (e.g., by right-clicking on the date-time expression in the document) thereby invoking a menu. The menu may include a command that allows the user to make a calendar entry corresponding to the selected date-time expression. In some embodiments of the invention, after selecting the menu command, the user may be presented with a dialog box for calendar entries with the date and time fields populated in accordance with the date-time expression.

In some embodiments of the invention, a icon may be provided in a user interface to indicate that a document includes a date-time expression. Using the icon, the user may identify which documents include date-time expressions that may refer to various events. In some embodiments of the invention, when the user hovers over the icon, the date-time expression included in the document may be provided to the user. In some embodiments of the invention, the date-time expression may be provided to the user in a canonical date-time format.

In some embodiments of the invention, the icon may be provided in a first color for documents that include a date-time expression that has been detected by the processing module but does not have a corresponding calendar entry and in a second color for documents that include a date-time expression that has been detected and has a corresponding calendar entry. For example, a gray icon may indicate that date-time expression has been detected but does not have a corresponding calendar entry, while an orange icon may indicates that the date-time expression already corresponds to a calendar entry. The different colors help the user identify those date-time expressions that have not been added to the calendar.

In some embodiments of the invention, when the user clicks on the icon, the document may be displayed with one or more date-time expressions included therein highlighted. In some embodiments of the invention, various color schemes may be used to indicate different characteristics of the date-time expressions in the document. For example, a light version of a color may be used to mark dates without times, which often correspond to reminders or all day events; a darker version of the color may be used to mark appointments that have specific times associated therewith; and a darkest version of the color may be used for multi-day events.

In some embodiments of the invention, a user may view all documents that include date-time expressions corresponding to a certain date through a calendar view in a user interface associated in the email system. In some embodiments of the invention, when the user selects a date in the calendar view (i.e., by right-clicking on the date), a list of documents that include a date-time expression corresponding to that date is provided. In some embodiments of the invention, the user may select one of the documents. In response, the document is provided to the user with the corresponding date-time expression highlighted. In some embodiments of the invention, if the document includes more that one date-time expression, only the date-time expression that which matches the date selected by the user is highlighted.

Other objects and features of the invention will become apparent from the following detailed description considered in connection with the accompanying drawings. The drawings are designed for purposes of illustration only and the invention is not limited to the particulars shown therein. Various alternatives and modifications within the scope of the invention will be apparent from the description contained herein.

### BRIEF DESCRIPTION OF THE DRAWINGS

FIG. 1 illustrates a system useful identifying, handling, and searching for email messages that include references to dates and times, according to one embodiment of the invention.

FIG. 2 illustrates an operation of a processing module that processes date-time expressions in documents according to one embodiment of the invention.

FIG. 3 illustrates various search options that may be provided to a user through a graphical user interface according to various embodiments of the invention.

FIG. 4a and FIG. 4b illustrate user interfaces useful for creating a calendar event from a date-time expression included in a document according to various embodiments the invention.

FIGS. 5a, 5b, and 5c illustrate user interfaces with icons that indicate whether a document includes date-time expressions according to various embodiments of the invention.

FIG. 6a and FIG. 6b illustrate user interfaces through which users may view documents related to a certain date according to various embodiments of the invention.

### DETAILED DESCRIPTION OF THE INVENTION

Various embodiments of the invention are described below that integrate aspects of a calendaring system with a document management system such as an email system that includes one or more email messages. However, it will become apparent from reading the following specification how various aspects of the invention may be used with other types of document management systems.

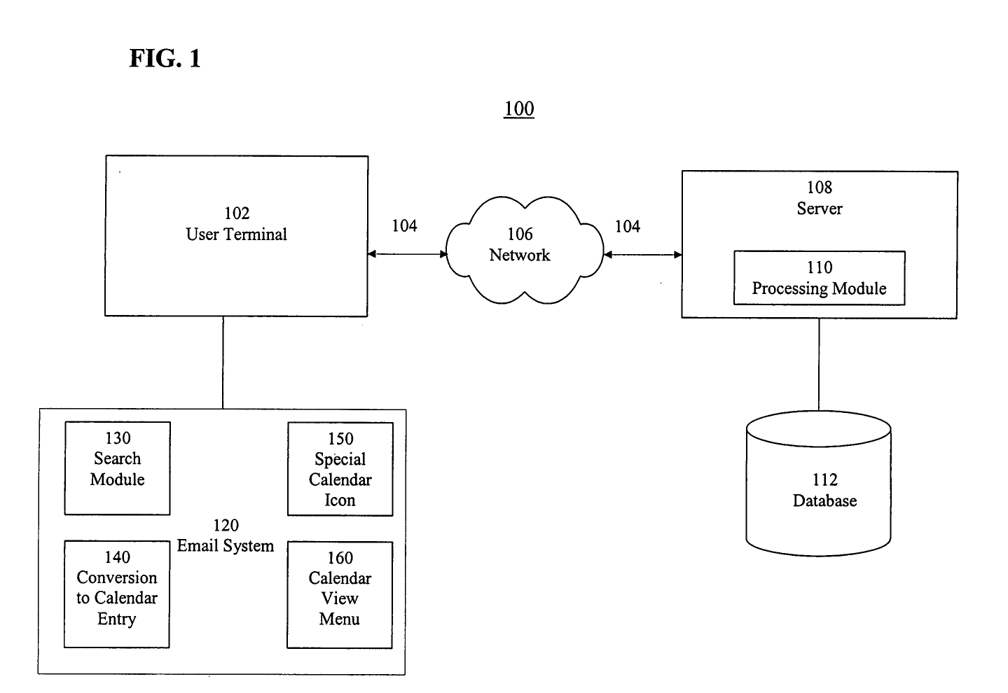

FIG. 1 illustrates a system 100 that may be used to identify, handle, and/or search for documents, such as email messages, that include one or more reference to dates and/or times regardless of syntax or context in which the date and/or time is expressed in the document, according to various embodiments of the invention. In some embodiments of the invention, system 100 includes an email system 120 that incorporates or otherwise operates in conjunction with a processing module 110. In some embodiments of the invention, procession module 110 converts each date-time expression included in a document into a canonically formatted date-time, so that subsequent comparisons may be made.

As illustrated in FIG. 1, processing module 110 may be utilized on a server 108. Although various aspects of the invention are described utilizing processing module 110 on server 108, those skilled in the art will recognize that processing module 110 may be located on user terminal 102 or any machine or machines associated with user terminal 102 as well.

Server 108 may be or include, for example, a workstation running Microsoft Windows™ NT™, Microsoft Windows™ 2000, Unix, Linux, Xenix, IBM, AIX™, Hewlett-Packard UX™, Novell Netware™, Sun Microsystems Solaris™, OS/2™, BeOS™, Mach, Apache, OpenStep™, or other operating system or platform.

User terminal 102 may be operatively coupled to server 108 over a network 106 via a communications link 104. Examples of user terminal 102 may include any one or more of, for example, a desktop computer, a laptop or other portable computer, a hand-held computer device such as a Blackberry, a Personal Digital Assistant (PDA), a web-enabled mobile phone, or a Palm Pilot, or any other computer device.

Network 106 may include any one or more networks. For example, network 106 may include the Internet, an intranet, a PAN (Personal Area Network), a LAN (Local Area Network), a WAN (Wide Area Network), a SAN (Storage Area Network), a MAN (Metropolitan Area Network), or other network.

Communications link 104 may include any one or more communications links. For example, communications link 104 may include a copper telephone line, a Digital Subscriber Line (DSL) connection, a Digital Data Service (DDS) connection, an Ethernet connection, an Integrated Services Digital Network (ISDN) line, an analog modem connection, a cable modem connection, a wireless connection, or other communications link.

In some embodiments of the invention, processing module 110 processes incoming documents upon their arrival in email system 120. Processing module 110 attempts to determine whether any of the incoming documents include date-time expressions. If so, in some embodiments of the invention, the date-time expressions are stored in a database 112. As illustrated in FIG. 1, database 112 may be operatively coupled to a server 108. Although illustrated in this manner, it shall be understood by those skilled in the art that database 112 may be located on user terminal 102 or any machine or machines associated with or accessible by user terminal 102.

Database 112 may store any type of data or information. Database 112 may include, or interface to, for example, the Oracle™ relational database sold commercially by Oracle Corporation, Informix™, DB2 (Database 2) or other data storage or query formats, platforms, or resources such as OLAP (On Line Analytical Processing), SQL (Standard Language Query), a SAN (storage area network), Microsoft Access™ or any other type of database.

As illustrated in FIG. 1, email system 120 may include one or more of the following four components: a search module 130, a conversion to calendar entry module 140, an icon module 150, and a calendar view module 160. Various one of these components may be used alone or in conjunction with one another to implement one or more aspects of the invention.

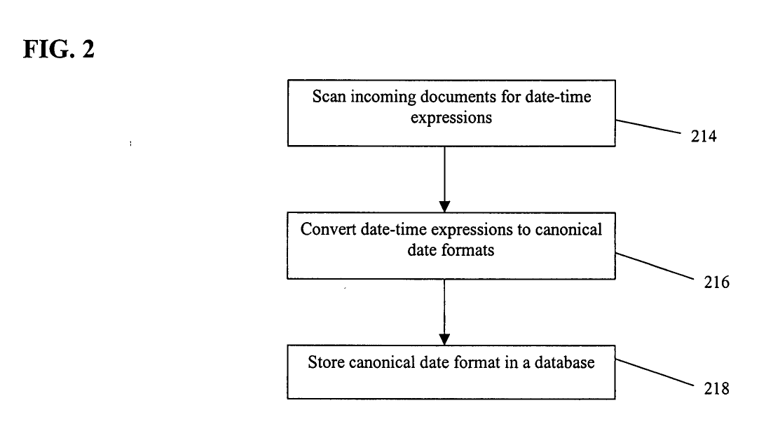

FIG. 2 illustrates an operation of processing module 110 that processes date-time expressions in documents according to one or more embodiments of the invention. In an operation 214, processing module 110 scans an incoming document for words, numbers, expressions, and other text that may correspond to dates and/or times, regardless of the syntax and/or context textual in which the date and/or time is expressed in the document. Date-time expressions include various references to dates and/or times including, but not limited to, December 31, 12/31/03, next Wednesday, Dec. 13, tomorrow, tonight, nine tonight, 9 pm, 21:00, or any other numbers, words, or expressions that may reference a date and/or time.

In an operation 216, processing module 110 converts each date-time expression located in the incoming document into a canonically formatted date-time. The date-time expressions are converted to canonically formatted date-time using heuristics, grammars, and/or contextual information as required. For example, in order to determine what the date-time expression “tomorrow” means requires knowledge of the date and/or time on which the message was created. The canonically formatted date-time provides a common format whereby subsequent comparisons may be made, regardless of the context or syntax associated with the original date-time expression. In some embodiments of the invention, the canonically formatted date-time corresponds to a format of dates and/or times used internally by, for example, email system 120, to store and/or process this type of information.

In an operation 218, the canonically formatted date-time associated with each document is stored as an entry in database 112. In some embodiments of the invention, each entry includes the canonically formatted date-time and a reference (such as a pointer) back to the corresponding document. In some embodiments of the invention, the reference or an additional reference may refer back to the corresponding date-time expression in the document.

In some embodiments of the invention, a search module 130 operating on or in conjunction with email system 120 performs a search for date related information that may be included in one or more email messages of email system 120. In some embodiments of the invention, a user may enter a desired date (or date range) through an appropriate user interface. In response, search module 130, alone or in cooperation with email system 120 and/or processing module 110, retrieves one or more documents that include date-time expressions corresponding to the desire date.

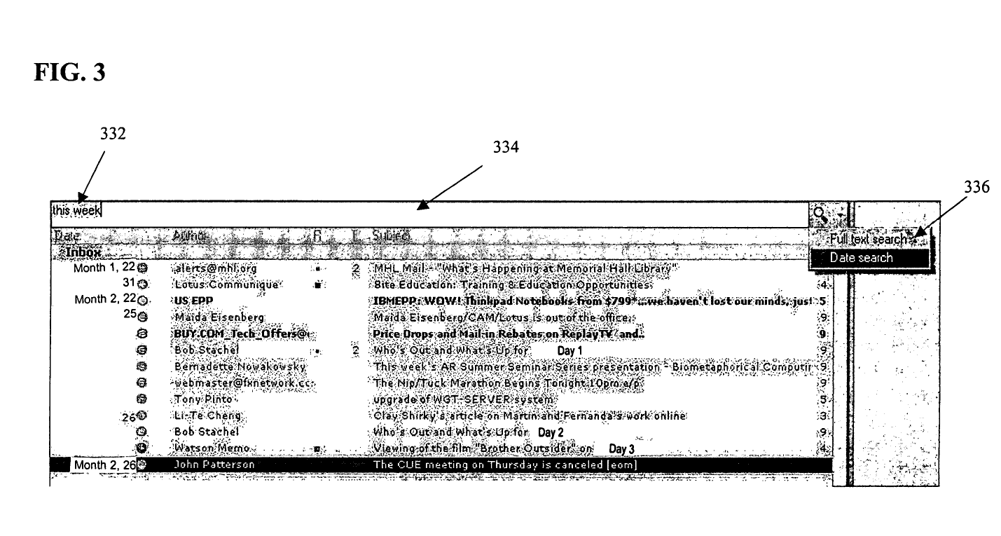

As illustrated in FIG. 3, a user may enter one or more search terms 332 in a query box 334 to initiate a search using search module 130. In the example illustrated in FIG. 3, desired date 332 includes the expression “this week.” In some embodiments of the invention, query box 334 may include or otherwise be associated with a menu, such as drop-down menu 336, to provide the user with various search options, including one or more of “full text search” or “date search.” Full text searches, which are generally known, enable a user to identify documents that include search terms 332 entered in query box 334. In this example, if the user specifies a full text search, search module 130 would return those documents that included the character strings “this,” “week,” or “this week” as would be apparent.

If the user specifies a date search, search module 130 operates to identify those documents that include date-time expressions that correspond to date or date range expressed by search terms 332. The search option “date search” as highlighted in FIG. 3.

In some embodiments of the invention, to perform a date search, search module 130 converts search terms 332 entered by the user to a canonically formatted date-time. Search terms 332 are converted to the canonically formatted date-time using heuristics, grammars and contextual information as needed, which may be similar to those used for date-time expressions discussed above. Converting search terms 332 to the canonically formatted date-time allows the date-time expressions included in the documents and also in the canonically formatted date-time to be compared with one another in a common frame of reference.

According to various embodiments of the invention, a user may enter search terms 332 using various syntax and context. For example, the user may use words such as “tomorrow” or, as illustrated in FIG. 3 “this week.” The user may also enter a desired date or date range as December 31 or 12/31/03. The user may also search for times in any time format, including 9 am, 9:00, “tomorrow at 9 am” or “this morning.”

Search module 130 searches database 112 for those database entries that include a canonically formatted date-time that matches that of the converted search terms 332. In some embodiments of the invention, upon locating one or more matching entries, search module 130 uses the references included in the entries to retrieve the document having a date-time expression that corresponds to search terms 332. In some embodiments of the invention, search module 130 may also use references to the actual date-time expression in the document. In some embodiments of the invention, search module 130 may also retrieve additional portions of the text in the document that provide a context for the date-time expression. The search results, are provided to the user.

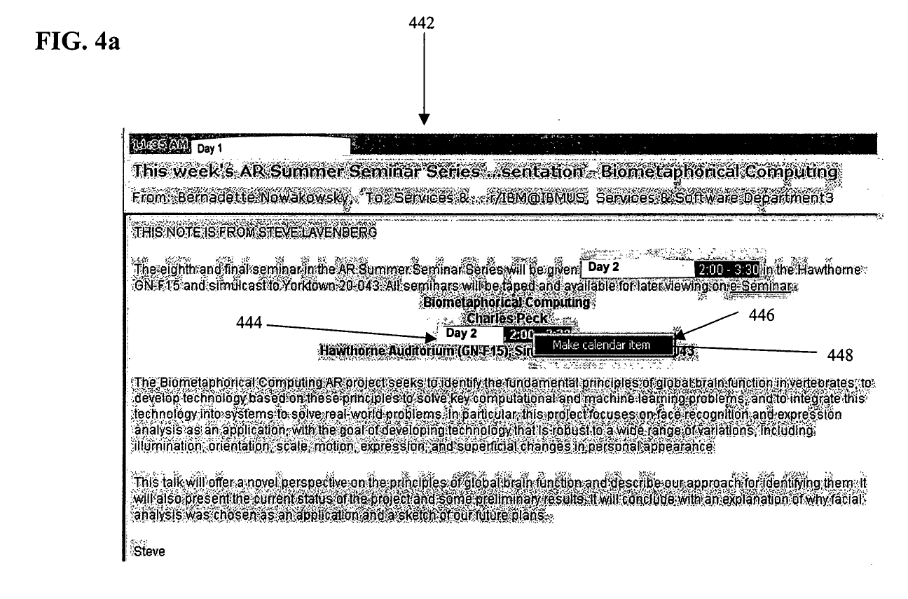

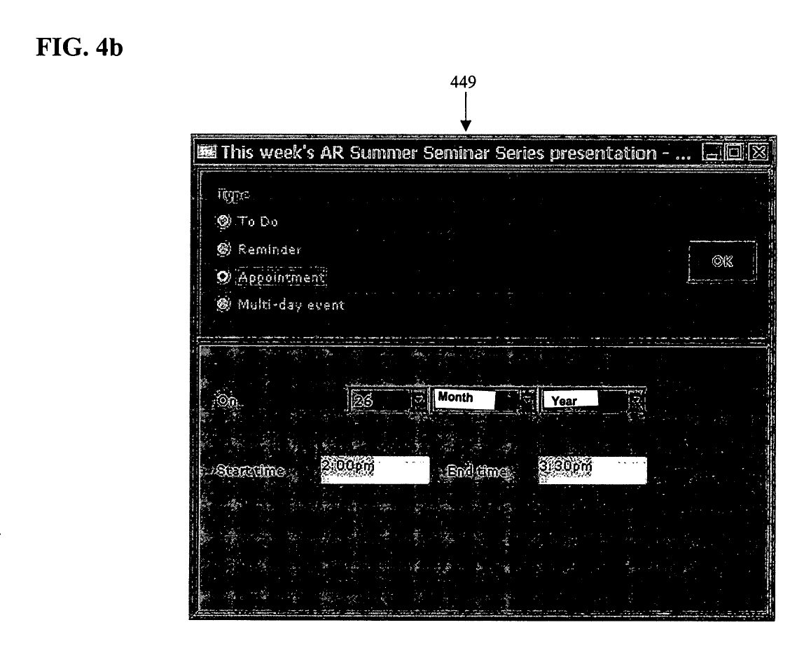

FIG. 4a and FIG. 4b illustrate user interfaces that are useful for creating a calendar event from a date-time expression included in a document according to various embodiments of the invention. In some embodiments of the invention, as illustrated in FIG. 4a, a user selects a date-time expression 444 in a document 442 by, for example, right-clicking on date-time expression 444, highlighting date-time expression 444, or other action which selects date-time expression 444. As illustrated in FIG. 4a, the selected date-time expression 444 corresponds to the date and time August 26, 2:00-3:30.

In some embodiments of the invention, after date-time expression 444 is selected, a menu 446 may be provided. Menu 446 may include one or more options including “Make Calendar Item” option 448. Selecting option 448 causes a calendar event corresponding to selected date-time expression 444 to be created in a calendaring system (not otherwise illustrated) that may be associated with email system 120.

In some embodiments of the invention, after selecting option 448, the user may be presented with a dialog box 449, as illustrated in FIG. 4b. In some embodiments of the invention, dialog box 449 may be presented to the user already populated with information corresponding to the selected date-time expression 444. As illustrated in FIG. 4b, dialog box 449 illustrates an appointment on Aug. 26, 2003 from 2:00 pm to 3:30 pm which corresponds to the selected date-time expression 444 in document 442 of “August 26, 2:00-3:30.” Once the user selects ‘OK,’ the appointment is created as a calendar event in the calendaring system.

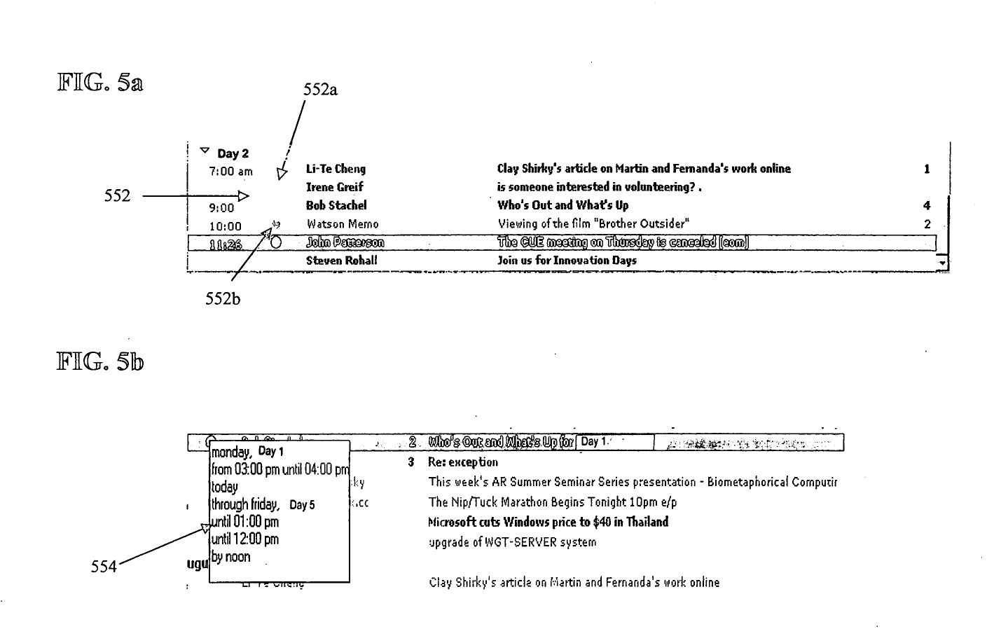

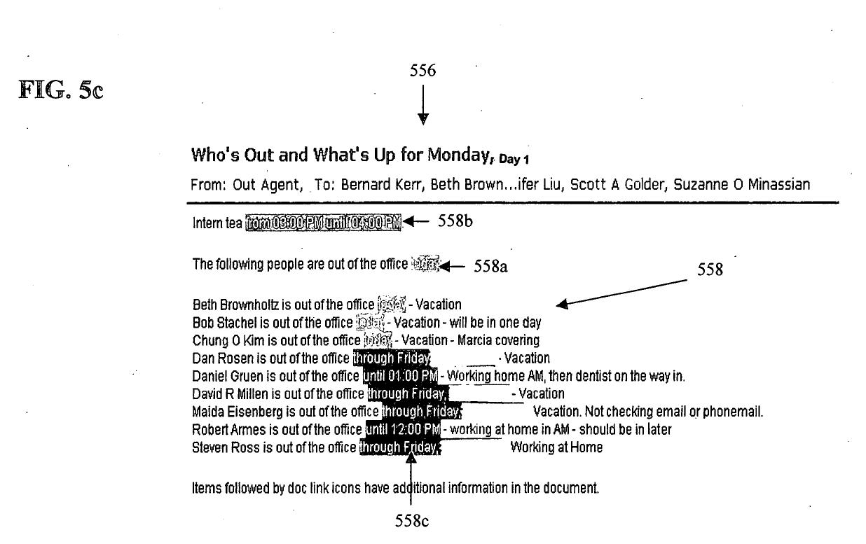

FIGS. 5a, 5b, and 5c illustrate user interfaces with icons that indicate whether documents include date-time expressions according to various embodiments of the invention. In some embodiments of the invention, a user interface 550 includes a calendar icon 552 that indicates whether a document includes a date-time expression. Calendar icon 552 allows a user to identify those messages that include meetings, events, or any other reference to a dates and/or times. As illustrated in FIG. 5a, a calendar icon 552 is associated with each of the documents included in user interface 550.

In some embodiments of the invention, calendar icon 552 may have a first color when the document includes a date-time expression that has not been entered as a calendar event and a second color when that document includes a date-time expression that has been entered as or is otherwise associated with a calendar event. For example, as illustrated in FIG. 5a, a calendar icon 552a may have a first color that indicates that the date-time expression included in the document has not been entered as a calendar event, while a calendar icon 552b may have a second color that indicates that the date-time expression included in the document has been entered as or is otherwise associated with a calendar event. Using different colors allows the user to identify those documents that include date-time expressions that, for example, are not reflected in the user's calendaring system.

In some embodiments of the invention, such as that illustrated in FIG. 5b, a user interface 551 may include a summary 554 that is presented to the user when, for example, the user hovers over calendar icon 552. Summary 554 includes one or more date-time expressions found in the document. Summary 554 provides the user with the date-time expressions found in the document without requiring the user to open the document.

In some embodiments of the invention, the user may open the document by selecting calendar icon 552 associated with that document. When the document is opened in this manner, the document is presented to the user with the date-time expressions highlighted. FIG. 5c illustrates a document opened in accordance with this aspect of the invention. Various colors may be used to indicate different characteristics of highlighted date-time expressions 558 in document 556. For example, a light version of a color may be used to highlight date-time expressions, such as date-time expression 558a, that include date information but do not include time information. These types of date-time expressions often correspond to reminders or all day events. A darker version of the color may be used to highlight date-time expressions, such as date-time expression 558b, that include both date and time information. These typically correspond to appointments, meetings, or other similar events. A darkest version of the color may be used to highlight date-time expression, such as date-time expression 558c, that include date information over several dates. These typically correspond to multi-day event. As would be apparent, any color scheme may be used to indicate different characteristics of highlighted date-time expressions 558 in document 556.

In some embodiments of the invention, icons or other indicia may be displayed on, with, alongside, adjacent or otherwise proximate to date and time regions in various calendar views presented to the user to indicate the existence of one or more documents with corresponding date-time expressions. These icons or indicia may inform or remind the user of an event related to the date and time region being viewed. In some embodiments of the invention, the user may add the event to their calendar through a user action or gesture, such as, but not limited to invoking a menu by hovering over the icon or indicia, dragging the icon or indicia onto a particular portion of the calendar, or other action or gesture as would be apparent.

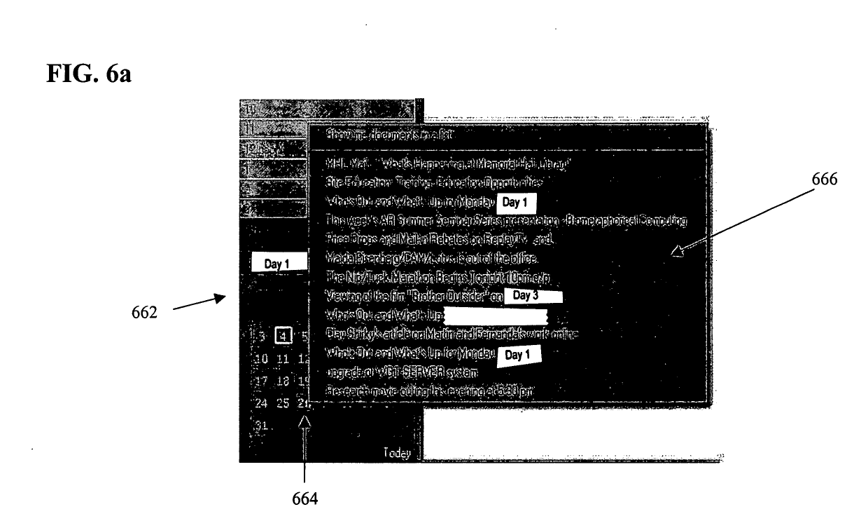

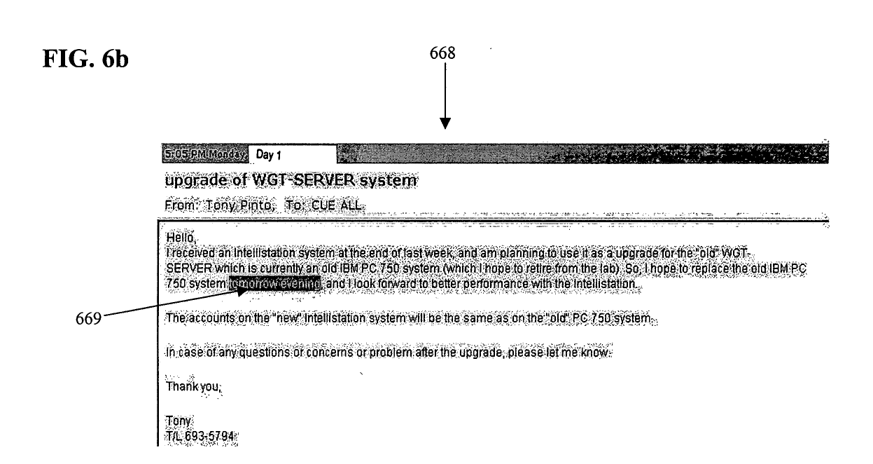

FIG. 6a and FIG. 6b illustrate various user interfaces through which a user may view documents related to a certain date according to one or more embodiments of the invention. According to various embodiments of the invention, a user may view one or more documents that include date-time expressions related to a selected date 664. In some embodiments of the invention, the user may select a date via calendar view 662. For example, as illustrated in FIG. 6a, a may select a date 664 on calendar view 662. The user may select date 664 by right-clicking on the date, highlighting the date, or any other action that selects the date as would be apparent. As illustrated in FIG. 6a, selected date 664 is Tuesday, the 26^{th} of MONTH1.

After the user selects date 664 on calendar view 662, a list 666 is provided. List 666 includes those documents that include date-time expressions that correspond to the selected date 664. Any of the documents listed in list 664 may be selected by the user to view the entire document.

FIG. 6b illustrates a user interface that presents a document 668 selected from list 666. As illustrated in FIG. 6b, the date-time expression 669 in document 668 that corresponds to the selected date 664 is highlighted. In some embodiments of the invention, if the document includes more that one date-time expression, only the date-time expression 669 that corresponds to the selected date 664 is highlighted. As illustrated in FIG. 6, the highlight date-time expression 669 is “tomorrow evening. In reference to the date on which this message was sent, the 25^{th} of MONTH 1, “tomorrow” corresponds to the 26^{th} of MONTH 1. This in turn corresponds to the date 664 selected by the user.

While particular embodiments of the present invention have been described, it is to be understood that modifications will be apparent to those skilled in the art without departing from the spirit of the invention. The scope of the invention is not limited to the specific embodiments descried herein. Other embodiments, uses and advantages of the invention will be apparent to those skilled in art from consideration of the specification and practice of the invention disclosed herein. The specification should be considered exemplary only, and the scope of the invention is accordingly intended to be limited by the following claims.

1. A method for identifying expressions of at least one of dates and times in documents comprising:
identifying at least one date-time expression in a document;
converting said at least one date-time expression into a canonically formatted date-time; and
storing said canonically formatted date-time in a database.

2. The method of claim 1, further comprising:
presenting the document to the user with the date-time expression highlighted.

3. The method of claim 1, further comprising:
presenting information associated with the document to the user via a graphical user interface, the information including indicia indicating that the document includes the date-time expression.

4. The method of claim 3, wherein said indicia comprises highlighting the information.

5. The method of claim 3, wherein said indicia comprises an icon.

6. The method of claim 5, further comprising:
in response to the user hovering over said icon, presenting the user with the date-time expression included in the document.

7. The method of claim 2, further comprising:
in response to the user selecting the date-time expression, providing a graphical user interface to the user, the graphical user interface associated with a calendar event for the date-time expression.

8. The method of claim 7, further comprising:
automatically populating one or more fields in the graphical user interface associated with the calendar event with at least one of date information and time information associated with the date-time expression.

9. The method of claim 8, further comprising:
causing the calendar event to be created in a calendaring system.

10. The method of claim 1, further comprising:
storing a reference with the canonically formatted date-time, the reference indicating a relationship between the canonically formatted date-time and at least one of the document and the date-time expression.

11. The method of claim 1, further comprising:
receiving a selected date from the user;
converting the selected date into a canonically formatted date-time;
determining whether the canonically formatted date-time corresponding to the selected date matches one or more of the canonically formatted date-times stored in the database.

12. A system for identifying and presenting expressions of at least one of dates and times in documents comprising:
a processing module, operable with a document management system, that identifies at least one date-time expression in a document managed by the document management system, wherein the date-time expression is not otherwise associated with a calendaring system; and
a graphical user interface, operable with at least said processing module, that presents said document with indicia identifying said document as including the date-time expression.

13. The system of claim 12, wherein said processing module identifies a plurality of date-time expressions in the document.

14. The system of claim 12, wherein said processing module identifies one or more date-time expressions in each of a plurality of documents.

15. The system of claim 14, wherein said graphical user interface presents a list of documents, said list of documents including said plurality of documents having one or more date-time expressions therein, each of said plurality of documents having indicia identifying it as including the date-time expression.

16. The system of claim 15, wherein said processing module receives a selection from a user with regard to one of said plurality of documents and causes a calendar event associated with the date-time expression included in the one of said plurality of documents to be created, said calendar event associated with the calendaring system.

17. The system of claim 16, wherein said processing module populates a graphical user interface associated with the calendar event with at least one of date and time information based on the date-time expression.

18. The system of claim 12, further comprising a search module that compares one or more search terms provided by a user with the date-time expression included in the document, said search terms expressing at least one of date and time information.

19. The system of claim 18, wherein the date-time expression included in the document is converted into a first canonically formatted date-time, wherein the one or more search terms are converted into a second canonically formatted date-time, and wherein said search module compares said first canonically formatted date-time with said second canonically formatted date-time to determine whether they pertain to at least a same date.
